(19) United States
(12) Patent Application Publication
(10) Pub. No.: US 2025/0079675 A1
(43) Pub. Date: Mar. 6, 2025

(54) FILTER COVER, RESONATOR, RF CAVITY FILTER AND COMMUNICATION DEVICE

(71) Applicant: Telefonaktiebolaget LM Ericsson (publ), Stockholm (SE)

(72) Inventors: Bingjian NIU, BEIJING (CN); Weidong WANG, BEIJING (CN); Jun ZHENG, Beijing (CN); Yang LIU, BEIJING (CN); Xueyuan ZHANG, BEIJING (CN)

(73) Assignee: Telefonaktiebolaget LM Ericsson (publ), Stockholm (SE)

(21) Appl. No.: 18/726,276

(22) PCT Filed: Jan. 4, 2022
(86) PCT No.: PCT/CN2022/070137

§ 371 Date: Jul. 2, 2024

(51) Int. Cl. H01P 1/205

(52) U.S. Cl. CPC H01P 1/2053

(57) ABSTRACT

A filter cover, a resonator, an RF cavity filter comprising the filter cover or the resonator, and a communication device comprising the RF cavity filter are disclosed. A filter cover (2) according to an embodiment comprises, at its inner surface (21), at least one flexible flap (22, 23) for frequency tuning or coupling tuning, which extends from and substantially perpendicular to the inner surface (21). A resonator (3) according to an embodiment is made of a sheet metal, and is integrally formed with a body portion (31), a folded portion (32), and a flexible portion (33, 34, 35) which is connected to the body portion (31) or the folded portion (32) and is bendable with respect to the body portion (31) or the folded portion (32) for frequency tuning or coupling tuning.

### TECHNICAL FIELD

The present disclosure generally relates to the technical field of communication device, and more particularly, to a filter cover, a resonator, a radio frequency (RF) cavity filter comprising the filter cover or the resonator, and a communication device comprising the RF cavity filter.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including Legacy BS, Street Macro, Micro, Small Cell, and Advanced Antenna System (AAS).

In recent years, with the development of the 5th Generation (5G) communication, Multiple-Input and Multiple-Output (MIMO) technology is widely used, which requires a lot of filter units (FUs) to be integrated with AU or RU to save cost and space. For example, FUs may be soldered onto a radio mother board, a low pass filter (LPF) board, an antenna calibration (AC) board or a power splitter board. Thus, filters that are smaller and lighter with better performance are quite in demand.

Due to the insufficient reliability of ceramic waveguide (CWG) filters, RF cavity filters are widely used, which generally consists of resonators, a housing, a cover, tuning screws and fixed nuts. Traditional RF cavity filters are quite bulky, and one way of producing small RF cavity filters is by manufacturing the resonators, the housing and the cover from sheet metal. However, the tuning screws and fixed nuts can't be manufactured from sheet metal, leading to complex structure, bulky volume, and big weight. In some existing solutions, tabs for frequency or coupling tuning are integrally formed on the cover, so that tuning screws can be dispensed with. However, the tabs are formed by etching or cutting slots in the cover, which inevitably result in serious signal leakage, causing EMC issue in, for example, the radio remote unit (RRU).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a new RF cavity filter solution, which can suppress signal leakage and improve EMC performance.

According to a first aspect of the disclosure, there is provided a filter cover for closing a cavity which is defined by a housing and in which a plurality of resonators is disposed, the filter cover having an inner surface which faces the cavity, wherein the inner surface is provided with at least one flexible flap for frequency tuning or coupling tuning, which extends from and substantially perpendicular to the inner surface.

In an embodiment of the disclosure, the at least one flexible flap includes a first flexible flap for frequency tuning, which is arranged to substantially overlap a corresponding resonator after the filter cover is joined to the housing.

In an embodiment of the disclosure, the at least one flexible flap includes a second flexible flap for coupling tuning, which is arranged to be located between two adjacent resonators after the filter cover is joined to the housing.

In an embodiment of the disclosure, the filter cover is not provided with any hole or slot for tuning.

According to a second aspect of the disclosure, there is provided an RF cavity filter, comprising: a housing defining a cavity; a plurality of resonators disposed in the cavity; and a filter cover according to the first aspect of the disclosure.

In an embodiment of the disclosure, each of the plurality of resonators extends in a first direction from a first end which is fixed to a bottom wall of the housing to a second end which is directed towards and spaced from the inner surface of the cover.

In an embodiment of the disclosure, each of the plurality of resonators is made of a sheet metal, and has a body portion extending in a first plane and a folded portion formed at the second end by bending the sheet metal.

In an embodiment of the disclosure, the folded portion extends substantially in a second plane which is parallel to the inner surface of the cover.

In an embodiment of the disclosure, the folded portion and the first flexible flap for frequency tuning are arranged at opposite sides of the the body portion.

In an embodiment of the disclosure, the first plane is parallel to a side wall of the housing, and the at least one flexible flap extends in a plane substantially parallel to the first plane and the side wall of the housing.

In an embodiment of the disclosure, the side wall of the housing is provided with at least one hole at a position corresponding to a free end of the at least one flexible flap.

In an embodiment of the disclosure, the at least one hole is sealed off after the frequency tuning or the coupling tuning is completed.

In an embodiment of the disclosure, at least two of the plurality of resonators is made of a single sheet metal.

In an embodiment of the disclosure, the first ends of the at least two resonators are connected to each other by an integrated coupling line.

According to a third aspect of the disclosure, there is provided a resonator for an RF cavity filter, the resonator being made of a sheet metal, extending in a first direction from a first end to a second end, and having a body portion extending in a first plane. The second end is provided with a folded portion which is formed by bending the sheet metal and extends in a second plane substantially perpendicular to the first direction, and an integrated flexible portion which is connected to the folded portion or the body portion and is bendable with respect to the folded portion or the body portion for frequency tuning or coupling tuning.

In an embodiment of the disclosure, the flexible portion comprises a first flexible portion which extends from a first edge of the folded portion in an opposite direction of the folded portion with respect to the body portion, and an angle between the first flexible portion and the folded portion or the body portion can be changed for frequency tuning.

In an embodiment of the disclosure, the flexible portion comprises a second flexible portion which extends substantially in the second plane from a second edge of the folded portion that is different from the first edge, and an angle between the second flexible portion and the folded portion can be changed for coupling tuning.

In an embodiment of the disclosure, the flexible portion comprises a third flexible portion which extends substantially in the first plane from an edge of the body portion, and an angle between the third flexible portion and the body portion can be changed for coupling tuning.

In an embodiment of the disclosure, the second flexible portion or the third flexible portion is substantially in an L shape, comprising a first segment which is connected to the second edge of the folded portion or the edge of the body portion and a second segment which is substantially perpendicular to the first segment.

According to a fourth aspect of the disclosure, there is provided an RF cavity filter, comprising: a housing defining a cavity; a cover joined to the housing and closing the cavity; and a plurality of resonators according to the third aspect of the disclosure disposed in the cavity.

In an embodiment of the disclosure, the first end of each resonator is fixed to a bottom wall of the housing, and the second end of each resonator is directed towards and spaced from an inner surface of the cover that faces the cavity.

In an embodiment of the disclosure, the cover is provided with at least one first hole at a position corresponding to the first flexible portion.

In an embodiment of the disclosure, the cover is provided with at least one second hole at a position corresponding to the second flexible portion.

In an embodiment of the disclosure, the first plane is parallel to a side wall of the housing, and the side wall of the housing is provided with at least one hole at a position corresponding to the third flexible portion.

In an embodiment of the disclosure, the at least one first hole of the cover, the at least one second hole of the cover, or the at least one hole of the side wall of the housing, is sealed off after the frequency tuning or the coupling tuning is completed.

In an embodiment of the disclosure, the second flexible portion or the third flexible portion of a first resonator and the second flexible portion or the third flexible portion of an adjacent second resonator form an interdigital structure.

In an embodiment of the disclosure, at least two of the plurality of resonators is made of a single sheet metal.

In an embodiment of the disclosure, the first ends of the at least two resonators are connected to each other by an integrated coupling line.

According to a fifth aspect of the disclosure, there is provided a communication device, comprising at least one RF cavity filter according to the second or fourth aspect of the disclosure.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIGS. 1A and 1B illustrate an RF cavity filter according to a first embodiment of the disclosure;

FIGS. 2A and 2B illustrate a housing of the RF cavity filter of the first embodiment;

FIGS. 3A and 3B illustrate a cover of the RF cavity filter of the first embodiment;

FIGS. 4A to 4C illustrate resonators of the RF cavity filter of the first embodiment;

FIGS. 5A to 5D illustrate an example of frequency tuning in the RF cavity filter of the first embodiment;

FIGS. 6A to 6D illustrate an example of coupling tuning in the RF cavity filter of the first embodiment;

FIG. 7A illustrates an RF cavity filter according to a variant of the first embodiment, and FIGS. 7B and 7C illustrate a cover of the RF cavity filter;

FIGS. 8A and 8B illustrate an RF cavity filter according to a second embodiment of the disclosure;

FIGS. 9A to 9C illustrate resonators of the RF cavity filter of the second embodiment;

FIGS. 10A to 10D illustrate an example of frequency tuning in the RF cavity filter of the second embodiment;

FIGS. 11A to 11F illustrate an example of coupling tuning in the RF cavity filter of the second embodiment;

FIGS. 12A and 12B illustrate an RF cavity filter according to a third embodiment of the disclosure;

FIGS. 13A to 13C illustrate resonators of the RF cavity filter of the third embodiment; and

FIGS. 14A to 14F illustrate an example of coupling tuning in the RF cavity filter of the third embodiment.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

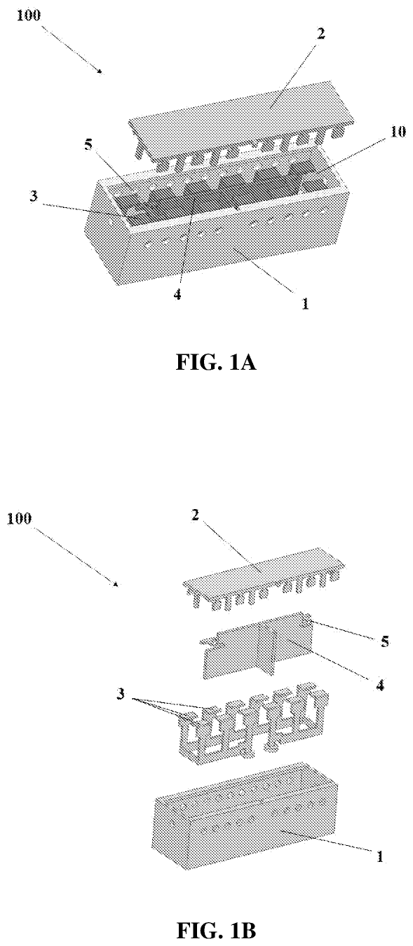

FIGS. 1A and 1B illustrate an RF cavity filter 100 according to a first embodiment of the disclosure, wherein FIG. 1A is a perspective view and FIG. 1B is an exploded view. As shown in FIGS. 1A and 1B, the RF cavity filter 100 includes a housing 1, a cover 2, resonators 3, an interior wall 4 and coupling bars 5. The housing 1 defines a cavity 10 and has an opened end. The resonators 3, the interior wall 4 and the coupling bars 5 are housed in the cavity 10. The cover 2 is joined to the opened end of the housing 1 and close the cavity 10. In the perspective view of FIG. 1A, the cover 2 is shown as being spaced from the housing 1, so as to display the interior of the RF cavity filter 100.

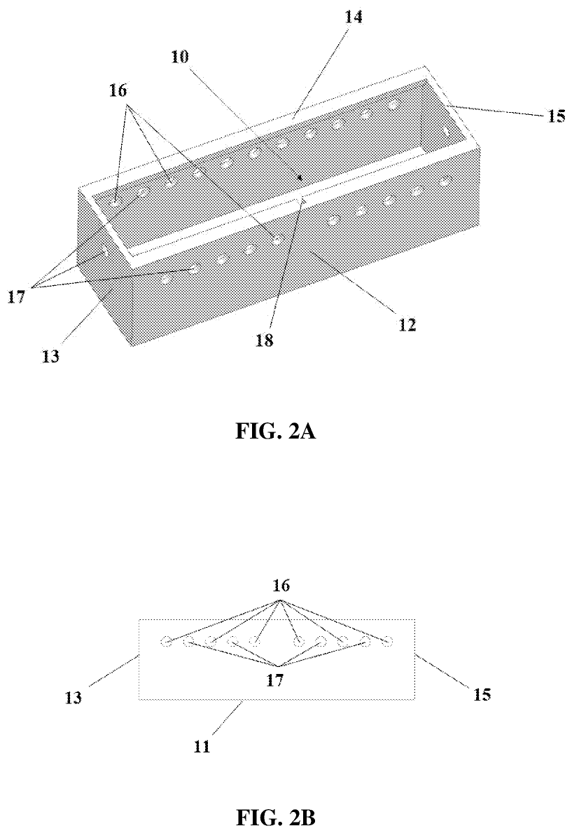

FIGS. 2A and 2B illustrate the housing 1 of the RF cavity filter 100, wherein FIG. 2A is a perspective view, and FIG. 2B is a front view. The housing 1 may include a bottom wall 11 and four side walls 12, 13, 14, 15. The housing 1 may be made of metal, such as aluminum or aluminum alloy. For example, the housing 1 may be manufactured from a single metal sheet by folding up the side walls 12, 13, 14, 15 from the bottom wall 11. The housing 1 may also be made in one piece by being e.g. deep-drawn, punched, extruded or die-casted. Alternatively, the bottom wall 11 and the side walls 12, 13, 14, 15 may be separate parts that are e.g. soldered or welded together to form the housing 1.

In this embodiment, a plurality of holes 16 and a plurality of holes 17 are alternatively provided in each of the side walls 12 and 14, and the side walls 13 and 15 are also each provided with one hole 17. The role of the holes 16 and 17 will be described later. On an inner upper edge of the side wall 12, a recess 18 is formed at a generally central portion of the side wall 12. The bottom wall 11 is provided with an input port and an output port, which are not shown. An input terminal may be connected to the input port, and an output terminal may be connected to the output port.

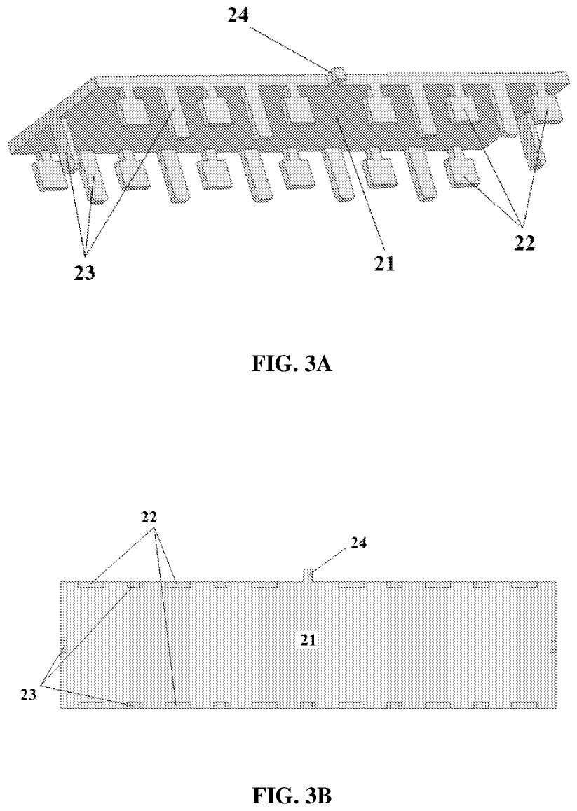

FIGS. 3A and 3B illustrate the cover 2 of the RF cavity filter 100, wherein FIG. 3A is a perspective view, and FIG. 3B is a bottom view. The cover 2 may be made of a sheet metal, which may be identical to or different from that of the housing 1. The cover 2 is joined to the opened end of the housing 1 by e.g. soldering or welding, and has an inner surface 21 which faces the cavity 10. In this embodiment, the inner surface 21 is provided with a plurality of flexible flaps 22, 23 at the periphery of the cover 2, which correspond to the holes 16, 17 of the housing 1, respectively. The flexible flaps 22, 23 in this embodiment can be easily formed by bending the sheet metal. Each of the flexible flaps 22, 23 extends from and substantially perpendicular to the inner surface 21. The shape or size of the flexible flaps 22, 23 is not limited to that shown in FIG. 3A. The cover 2 is further provided with a protrusion 24 at a generally central portion of an edge thereof. The protrusion 24 extends in the same plane as that of the cover 2 and projects outwards from the edge, and is fitted into the recess 18 on the side wall 12 of the housing 1.

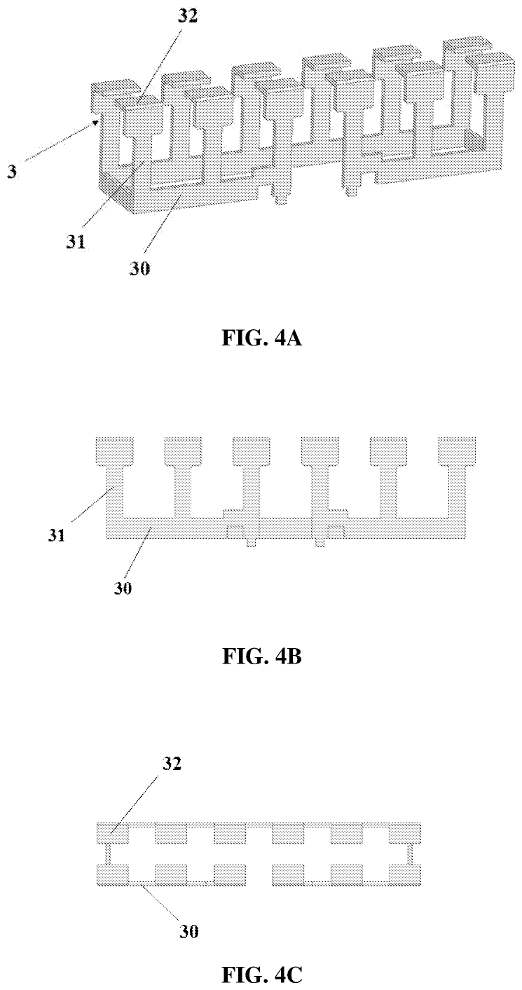

FIGS. 4A to 4C illustrate the resonators 3 of the RF cavity filter 100, wherein FIG. 4A is a perspective view, FIG. 4B is a front view, and FIG. 4C is a top view. In this embodiment, a plurality of resonators 3 are made in one piece and manufactured from a single metal sheet, which simplifies the assembly of the RF cavity filter 100. Each resonator 3 extends in a first direction from a first end to a second end. The first end is joined to the bottom wall 11 of the housing 1 by e.g. soldering or welding. The second end is directed towards and spaced from the inner surface 21 of the cover 2. The first ends of two adjacent resonators 3 are connected to each other by an integrated coupling line 30.

Each resonator 3 has a body portion 31 between the first end and the second end, which extends in a first plane parallel to the side walls 12, 14 of the housing 1. In the first plane, the body portion 31 has a larger cross section at the second end than the cross section at the first end. At the second end of each resonator 3, a folded portion 32 is formed by bending the sheet metal at an angle of about 90°, so as to extend substantially in a second plane which is parallel to the inner surface 21 of the cover 2. The folded portion 32 increases the cross-sectional area of the second end of the resonator 3 in the second plane, such that the capacitance between the second end of the resonator 3 and the inner surface 21 of the cover 2 is increased.

Turning back to FIGS. 1A and 1B, the interior wall 4 has a cross section generally in a T shape, and divides the cavity 10 into three chambers. The interior wall 4 separates the resonators 3 in one of the three chambers from the resonators 3 in the other two chamber, especially separating the input resonator which is connected to the input port from the output resonator which is connected to the output port. In this embodiment, the interior wall 4 is joined to the bottom wall 11 of the housing 1 by e.g. soldering or welding. Alternatively or additionally, the interior wall 4 may be joined to the inner surface 21 of the cover 2. In some other embodiments, the interior wall 4 may be inserted into grooves that are formed in the bottom wall 11 of the housing 1 and/or the inner surface 21 of the cover 2.

As shown in FIGS. 1A and 1B, at two upper corners of the interior wall 4 that are adjacent to the side walls 13, 15 of the housing 1, two coupling bars 5 are arranged at recessed portions of the interior wall 4. The coupling bars 5 serve to establish a cross-coupling between two resonators 3 housed in different chambers.

Hereinbelow, the frequency tuning and the coupling tuning of the RF cavity filter 100 according to the first embodiment will be described.

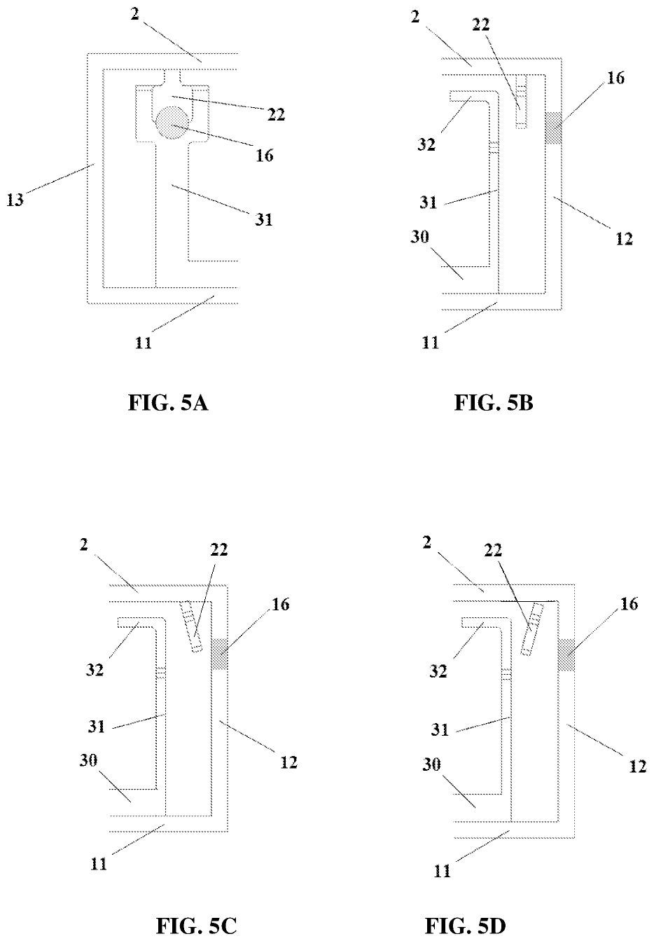

FIGS. 5A to 5D illustrate an example of tuning the frequency of one resonator 3 in the RF cavity filter 100, wherein FIG. 5A is a front view from a side of the side wall 12, and each of FIGS. 5B-5D is a side view from a side of the side wall 13. As shown in FIG. 5A, one of the flexible flaps 22 of the cover 2 is arranged to substantially overlap the resonator 3, and more specifically, the second end thereof, when viewed along a direction from the side wall 12 to the side wall 14 of the housing 1. As shown in FIGS. 5B-5D, the folded portion 32 of the resonator 3 and the flexible flap 22 of the cover 2 are arranged at opposite sides of the body portion 31 of the resonator 3. The free end of the flexible flap 22 terminates at a level corresponding to one of the holes 16 in the side wall 12 of the housing 1.

Initially, the flexible flap 22 extends in a plane substantially parallel to the first plane in which the body portion 31 of the resonator 3 extends, that is, parallel to the side wall 12 of the housing 1, as shown in FIG. 5B. To tune the frequency of the resonator 3, a tool (not shown) which is preferably provided with a hooked end may be inserted into the cavity 10 through the hole 16 in the side wall 12, so as to pull the flexible flap 22 towards the side wall 12 of the housing 1 as shown in FIG. 5C, or push the flexible flap 22 towards the resonator 3 as shown in FIG. 5D. Accordingly, the capacitance between the second end of the resonator 3 and the flexible flap 22 of the cover 2 is changed, and thus the frequency of the resonator 3 is tuned. After the frequency tuning is completed, the hole 16 is sealed off by a conductive film or a dielectric film.

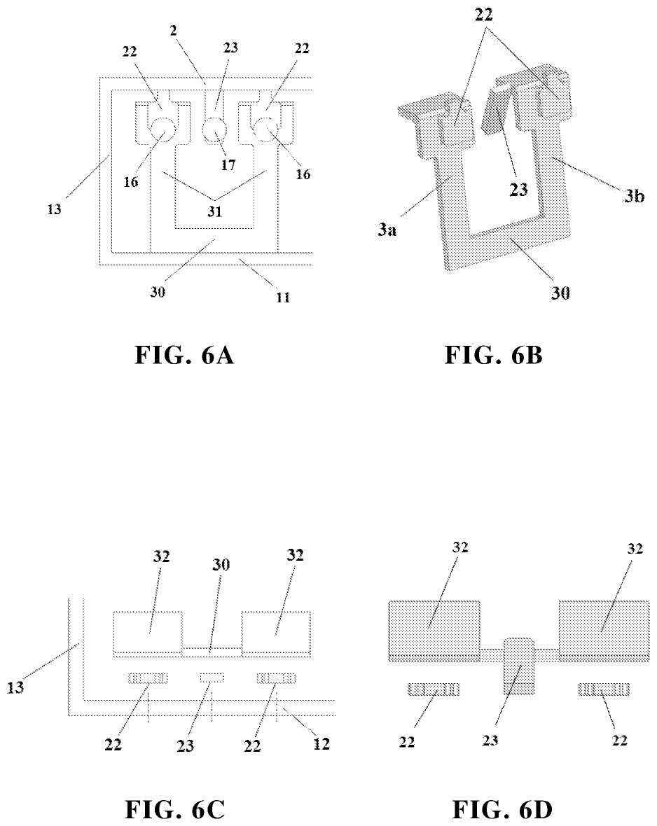

FIGS. 6A to 6D illustrate an example of tuning the coupling between two adjacent resonators 3a, 3b in the RF cavity filter 100, wherein FIG. 6A is a front view in an initial state, FIG. 6B is a perspective view after a coupling tuning operation, FIG. 6C is a top view in the initial state, and FIG. 6D is a top view after the coupling tuning operation. FIGS. 6A and 6C show the relative position of the flexible flaps 22, 23 of the cover 2 with respect to the two resonators 3a, 3b and the holes 16, 17 in the side wall 12 of the housing 1. In FIGS. 6B and 6D, the housing 1 and the cover 2 are not shown. As shown in FIG. 6A, the flexible flap 23 of the cover 2 is arranged to be located between the two adjacent resonators 3a, 3b when viewed along the direction from the side wall 12 to the side wall 14 of the housing 1, and also between two flexible flaps 22 corresponding to the two adjacent resonators 3a, 3b. The free end of the flexible flap 23 terminates at a level corresponding to one of the holes 17 in the side wall 12 of the housing 1.

Initially, the flexible flap 23 extends in a plane substantially parallel to the first plane in which the body portion 31 of the resonator 3a or 3b extends, that is, parallel to the side wall 12 of the housing 1, as shown in FIG. 6C. To tune the coupling between the resonator 3a and the resonator 3b, a tool (not shown) which is preferably provided with a hooked end may be inserted into the cavity 10 through the hole 17 in the side wall 12, so as to push the flexible flap 23 away from the side wall 12 as shown in FIGS. 6B and 6D, or pull the flexible flap 23 towards the side wall 12. Accordingly, the capacitance coupling between the resonator 3a and the resonator 3b is changed, and thus the total coupling between them is tuned. After the coupling tuning is completed, the hole 17 is sealed off by a conductive film or a dielectric film.

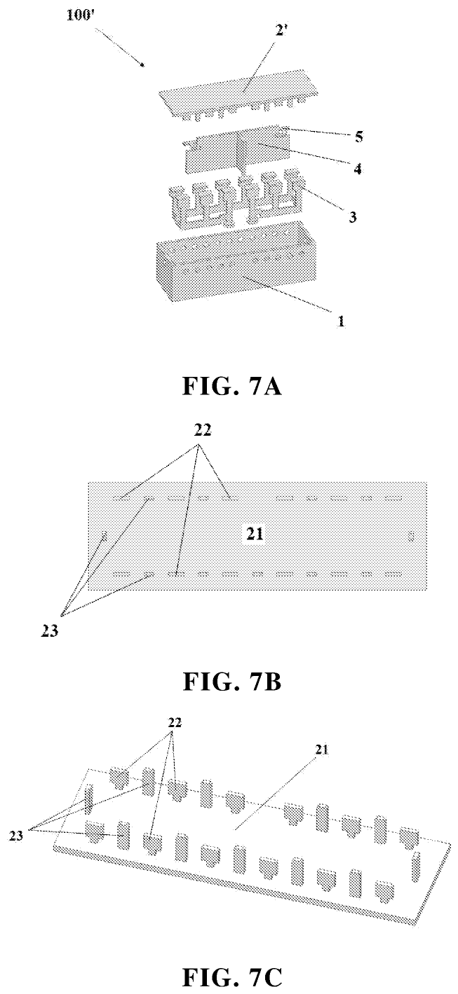

FIGS. 7A to 7C illustrate an RF cavity filter 100′ according to a variant of the first embodiment, wherein FIG. 7A is an exploded view of the RF cavity filter 100′, FIG. 7B is a bottom view of the cover 2′ of the RF cavity filter 100′, and FIG. 7C is an upside-down perspective view of the cover 2′. The RF cavity filter 100′ according to this variant differs from the above RF cavity filter 100 mainly in that the flexible flaps 22, 23 are not provided at the periphery of the cover. In this variant, the flexible flaps 22, 23 are soldered or welded to the inner surface 21 of the cover 2′ at positions inward of the periphery of the cover 2′. The flexible flaps 22, 23 can be arranged at different distances from the edge of the cover 2′. The housing 1, the resonators 3, the interior wall 4 and the coupling bars 5, as well as the frequency tuning and the coupling tuning, are the same as those in the first embodiment, so the detailed description thereof is omitted.

In the first embodiment and its variant as described above, a plurality of flexible flaps 22 for frequency tuning and a plurality of flexible flaps 23 for coupling tuning are provided, which extend from and substantially perpendicular to the inner surface 21 of the cover 2, 2′, and the cover 2, 2′ is not provided with any hole or slot for tuning. A plurality of holes 16, 17 are formed in the side walls of the housing 1 for insertion of a tool, but the holes 16, 17 are sealed off after the frequency tuning or the coupling tuning is completed. Therefore, no signal leakage will occur, and the EMC performance is improved.

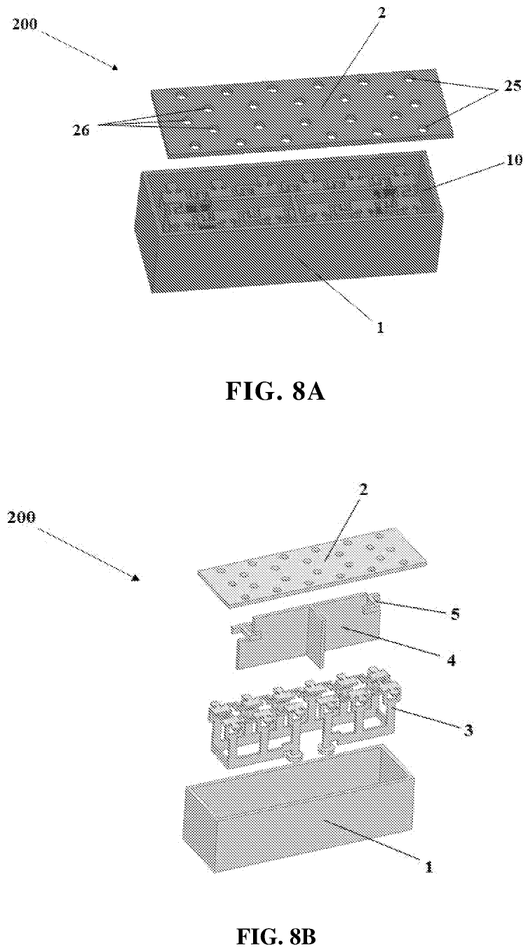

FIGS. 8A and 8B illustrate an RF cavity filter 200 according to a second embodiment of the disclosure, wherein FIG. 8A is a perspective view and FIG. 8B is an exploded view. Similar to the RF cavity filter 100 in the first embodiment, the RF cavity filter 200 also includes a housing 1, a cover 2, resonators 3, an interior wall 4 and coupling bars 5. Hereinbelow, description will be made mainly to the differences between the second embodiment and the first embodiment.

In the second embodiment, as can be seen from FIGS. 8A and 8B, the housing 1 does not have any hole 16 or 17 in the four side walls thereof; in contrast, a plurality of holes 25, 26 is provided on the cover 2, and the cover 2 is not provided with any flexible flaps.

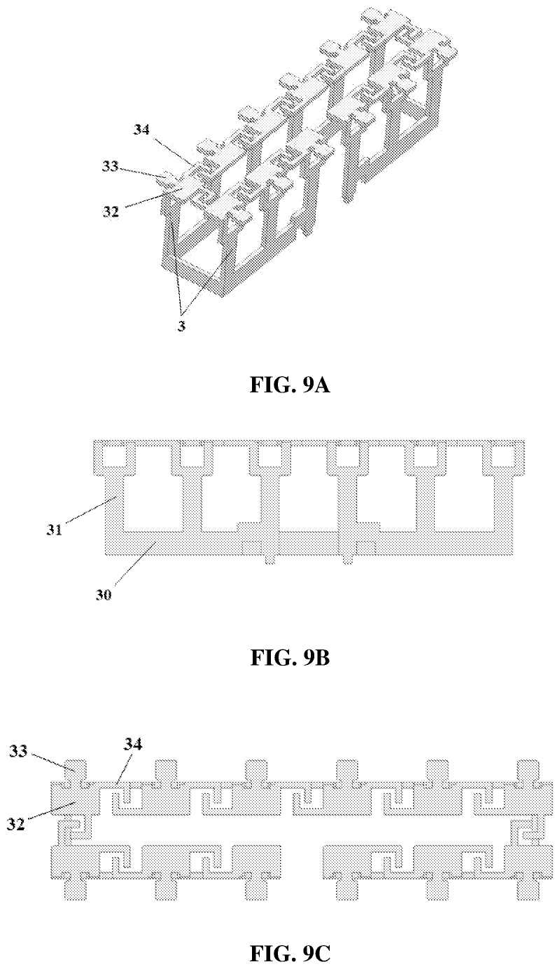

FIGS. 9A to 9C illustrate the resonators 3 of the RF cavity filter 200, wherein FIG. 9A is a perspective view, FIG. 9B is a front view, and FIG. 9C is a top view. In this embodiment, a plurality of resonators 3 are also made in one piece and manufactured from a single metal sheet, and each resonator 3 extends in a first direction from a first end to a second end. The first end is joined to the bottom wall 11 of the housing 1, and the second end is directed towards and spaced from the inner surface 21 of the cover 2. The first ends of two adjacent resonators 3 are connected to each other by an integrated coupling line 30.

Each resonator 3 has a body portion 31 between the first end and the second end, which extends in a first plane parallel to the side walls 12, 14 (referring to FIG. 2A) of the housing 1. In the first plane, the body portion 31 has a generally Y shape. At the second end of each resonator 3, a folded portion 32 is formed by bending the sheet metal at an angle of about 90°, so as to extend substantially in a second plane which is parallel to the inner surface 21 of the cover 2.

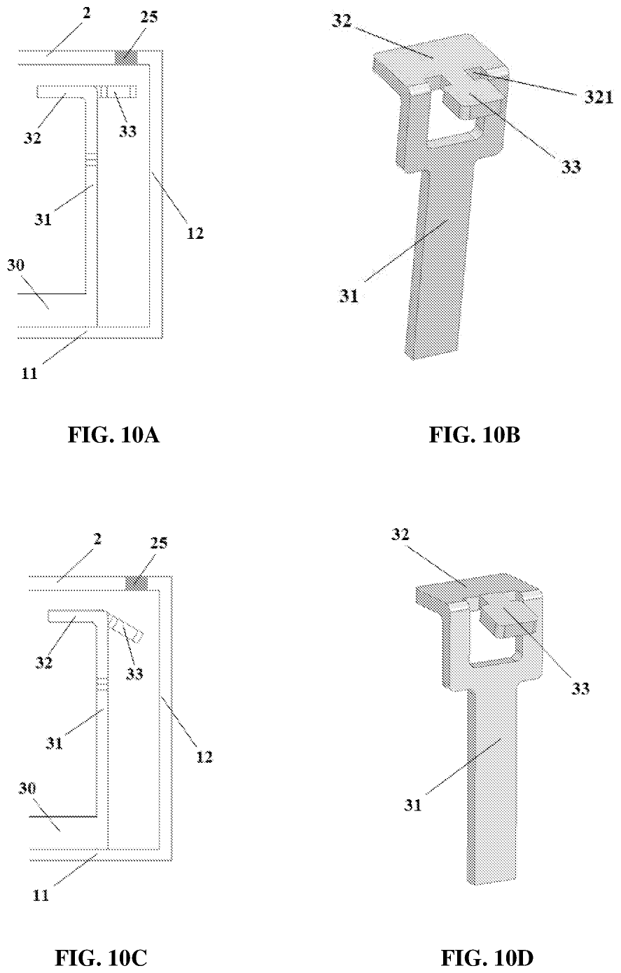

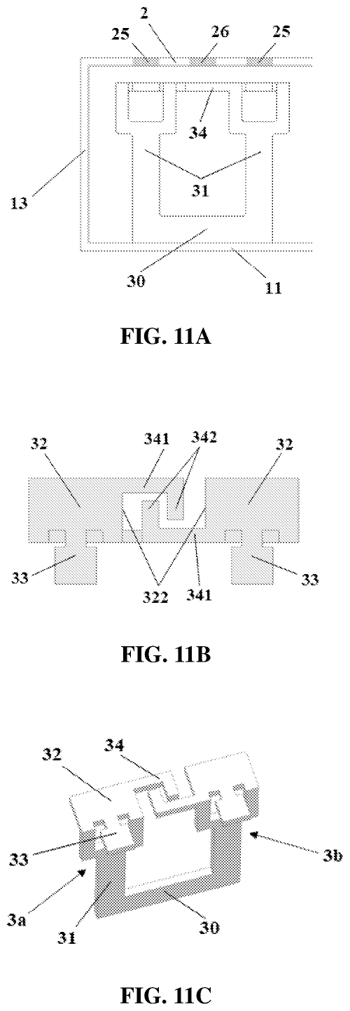

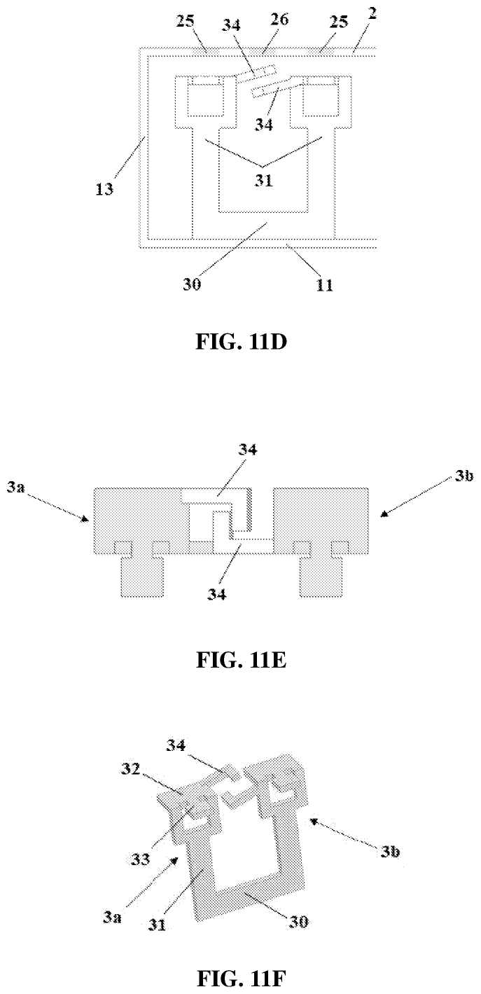

In the second embodiment, each resonator 3 is further integrally formed with a first flexible portion 33 and a second flexible portion 34. The first flexible portion 33 extends from a first edge 321 (see FIG. 10B) of the folded portion 32. In this embodiment, the folded portion 32 is connected to the body portion 31 at the first edge 321, and the first flexible portion 33 extends in an opposite direction of the folded portion 32 with respect to the body portion 31. An angle between the first flexible portion 33 and the folded portion 32 or the body portion 31 can be changed for frequency tuning. The second flexible portion 34 extends substantially in the second plane from a second edge 322 (see FIG. 11B) of the folded portion 32 that is different from the first edge 321. An angle between the second flexible portion 34 and the folded portion 32 can be changed for coupling tuning. The second flexible portion 34 is substantially in an L shape when viewed from the top of the resonator 3, i.e. from the cover 2. The L-shaped second flexible portion 34 comprises a first segment 341 which is connected to the second edge 322 of the folded portion, and a second segment 342 which is substantially perpendicular to the first segment 341.

Hereinbelow, the frequency tuning and the coupling tuning of the RF cavity filter 200 according to the second embodiment will be described. To enable the frequency tuning, the holes 25 in the cover 2 are arranged at positions corresponding to the first flexible portions 33 of the resonators 3. To enable the coupling tuning, the holes 26 in the cover 2 are arranged at positions corresponding to the second flexible portions 34 of the resonators 3.

FIGS. 10A to 10D illustrate an example of tuning the frequency of one resonator 3 in the RF cavity filter of the second embodiment, wherein FIG. 10A is a side view from a side of the side wall 13 in an initial state, FIG. 10B is a perspective view in the initial state, FIG. 10C is a side view after a frequency tuning operation, and FIG. 10D is a perspective view after the frequency tuning operation. FIGS. 10A and 10C show the relative position of the first flexible portion 33 of the resonator 3 with respect to the cover 2 and the housing 1. In FIGS. 10B and 10D, the housing 1 and the cover 2 are not shown. In addition, for the sake of clarity and convenience, the second flexible portion 34 is removed from the resonator 3.

Initially, the first flexible portions 33 extends substantially in the second plane in which the folded portion 32 extends, that is, parallel to the cover 2, as shown in FIG. 10A. To tune the frequency of the resonator 3, a tool (not shown) which is preferably provided with a hooked end may be inserted into the cavity 10 through the hole 25 in the cover 2, so as to push the first flexible portions 33 towards the bottom wall 11 of the housing 1 (i.e., towards the body portion 31 of the resonator 3) as shown in FIG. 10C, or pull the first flexible portions 33 towards the cover 2. Accordingly, the capacitance between the second end of the resonator 3 and the cover 2 is changed, and thus the frequency of the resonator 3 is tuned. After the frequency tuning is completed, the hole 25 is sealed off by a conductive film or a dielectric film.

FIGS. 11A to 11F illustrate an example of tuning the coupling between two adjacent resonators 3a, 3b in the RF cavity filter 200, wherein FIGS. 11A-11C show a front view, a top view, and a perspective view of the two adjacent resonators 3a, 3b in an initial state, and FIGS. 11D-11F show a front view, a top view, and a perspective view of the two adjacent resonators 3a, 3b after a coupling tuning operation. FIGS. 11A and 11D show the relative position of the second flexible portion 34 of the resonator 3 with respect to the cover 2 and the housing 1. In FIGS. 11B, 11C, 11E and 11F, the housing 1 and the cover 2 are not shown.

Initially, the second flexible portion 34 of each of the two resonators 3a, 3b extends substantially in the second plane in which the folded portion 32 extends, that is, parallel to the cover 2, as shown in FIG. 11A. The second flexible portion 34 of the resonator 3a and the second flexible portion 34 of the resonator 3b form an interdigital structure, as shown in FIGS. 11B and 11C.

To tune the coupling between the resonator 3a and the resonator 3b, a tool (not shown) which is preferably provided with a hooked end may be inserted into the cavity 10 through the hole 26 in the cover 2, so as to pull the second flexible portion 34 of one resonator 3a towards the cover 2 and push the second flexible portion 34 of the other resonator 3b towards the bottom wall 11 of the housing 1, as shown in FIGS. 11D-11F. Accordingly, the capacitance coupling between the resonator 3a and the resonator 3b is changed, and thus the total coupling between them is tuned. After the coupling tuning is completed, the hole 26 is sealed off by a conductive film or a dielectric film.

In the second embodiment as described above, a plurality of first flexible portion 33 for frequency tuning and a plurality of second flexible portion 34 for coupling tuning are provided, and a plurality of holes 25, 26 are formed in the cover 2 for insertion of a tool, but the holes 25, 26 are sealed off after the frequency tuning or the coupling tuning is completed. Therefore, no signal leakage will occur, and the EMC performance is improved.

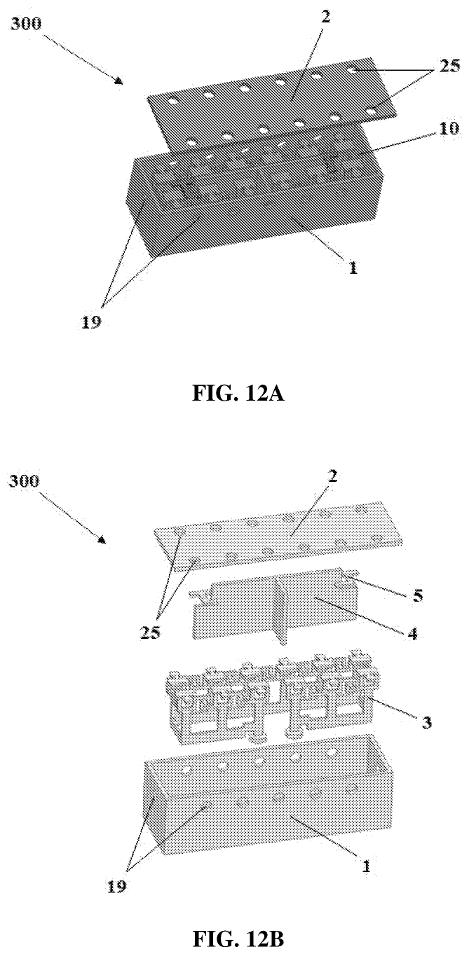

FIGS. 12A and 12B illustrate an RF cavity filter 300 according to a third embodiment of the disclosure, wherein FIG. 12A is a perspective view and FIG. 12B is an exploded view. Similar to the RF cavity filter 200 in the second embodiment, the RF cavity filter 300 also includes a housing 1, a cover 2, resonators 3, an interior wall 4 and coupling bars 5. Hereinbelow, description will be made mainly to the differences between the third embodiment and the second embodiment.

In the third embodiment, as can be seen from FIGS. 12A and 12B, the cover 2 is provided with a plurality of holes 25 as in the second embodiment, but does not have the holes 26 of the second embodiment, and the housing 1 is provided with a plurality of holes 19 in the four side walls. Like in the second embodiment, the cover 2 is not provided with any flexible flaps.

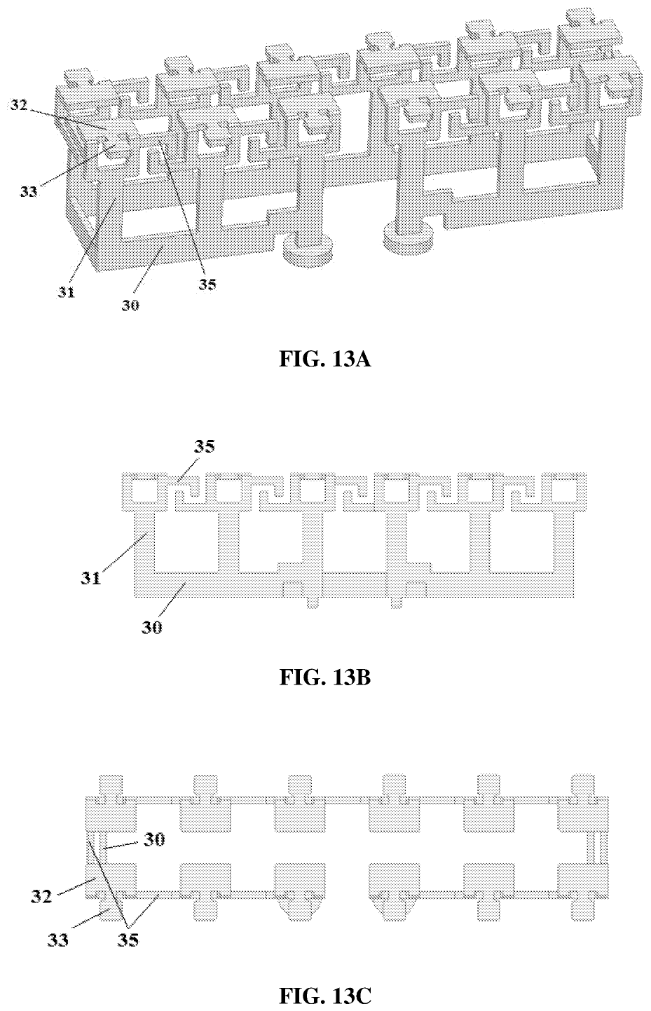

FIGS. 13A to 13C illustrate the resonators 3 of the RF cavity filter 300, wherein FIG. 13A is a perspective view, FIG. 13B is a front view, and FIG. 13C is a top view. In this embodiment, a plurality of resonators 3 are also made in one piece and manufactured from a single metal sheet, and each resonator 3 extends in a first direction from a first end to a second end. The first end is joined to the bottom wall 11 of the housing 1, and the second end is directed towards and spaced from the inner surface 21 of the cover 2. The first ends of two adjacent resonators 3 are connected to each other by an integrated coupling line 30.

Each resonator 3 has a body portion 31 between the first end and the second end, which extends in a first plane parallel to the side walls 12, 14 (referring to FIG. 2A) of the housing 1. In the first plane, the body portion 31 has a generally Y shape. At the second end of each resonator 3, a folded portion 32 is formed by bending the sheet metal at an angle of about 90°, so as to extend substantially in a second plane which is parallel to the inner surface 21 of the cover 2.

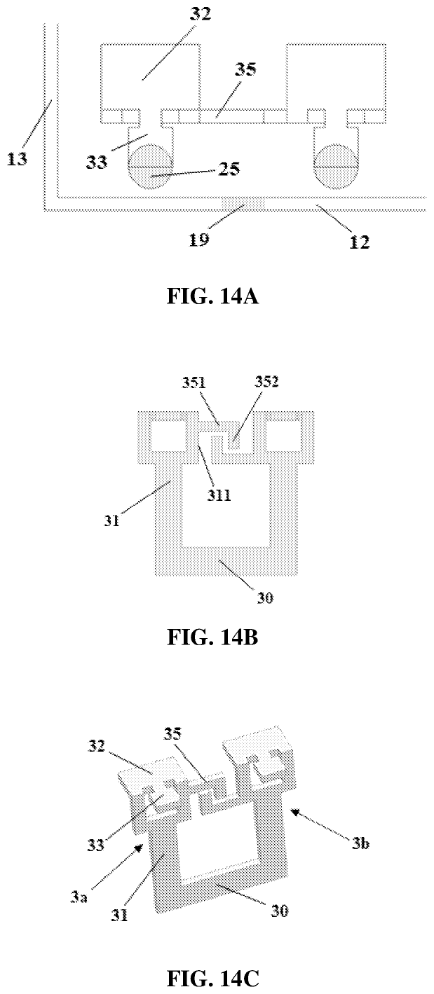

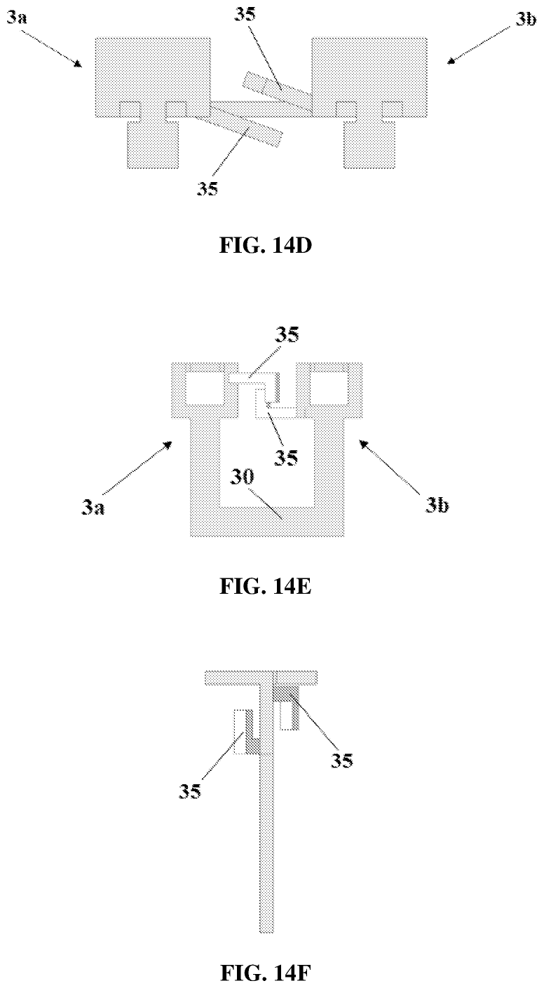

In the third embodiment, each resonator 3 is further integrally formed with a first flexible portion 33 and a third flexible portion 35. The first flexible portion 33 is identical to the first flexible portion 33 in the second embodiment. The third flexible portion 35 extends substantially in the first plane from an edge 311 (see FIG. 14B) of the body portion 31. An angle between the third flexible portion 35 and the body portion 31 can be changed for coupling tuning. The third flexible portion 35 is substantially in an L shape when viewed from the corresponding side wall of the cover 2. The L-shaped third flexible portion 35 comprises a first segment 351 which is connected to the edge 311 of the body portion 31, and a second segment 352 which is substantially perpendicular to the first segment 351.

To enable frequency tuning, the holes 25 in the cover 2 are arranged at positions corresponding to the first flexible portions 33 of the resonators 3. To enable coupling tuning, the holes 19 in the side walls of the housing 1 are arranged at positions corresponding to the third flexible portions 35 of the resonators 3. The frequency tuning in the third embodiment is the same as that in the second embodiment. Hereinbelow, the coupling tuning of the RF cavity filter 300 according to the third embodiment will be described.

FIGS. 14A to 14F illustrate an example of tuning the coupling between two adjacent resonators 3a, 3b in the RF cavity filter 300, wherein FIGS. 14A-14C show a top view, a front view, and a perspective view of the two adjacent resonators 3a, 3b in an initial state, and FIGS. 14D-14F show a top view, a front view, and a side view of the two adjacent resonators 3a, 3b after a coupling tuning operation. FIG. 14A shows the relative position of the third flexible portion 35 of the resonator 3 with respect to the housing 1. In FIGS. 14B-14F, the housing 1 and the cover 2 are not shown.

Initially, the third flexible portion 35 of each of the two resonators 3a, 3b extends substantially in the first plane in which the body portion 31 extends, that is, parallel to the side wall 12 of the housing 1, as shown in FIG. 14A. The third flexible portion 35 of the resonator 3a and the third flexible portion 35 of the resonator 3b form an interdigital structure, as shown in FIGS. 14B and 14C.

To tune the coupling between the resonator 3a and the resonator 3b, a tool (not shown) which is preferably provided with a hooked end may be inserted into the cavity 10 through the hole 19 in the side wall 12 of the housing 1, so as to pull the third flexible portion 35 of one resonator 3a towards the side wall 12 of the housing 1 and push the third flexible portion 35 of the other resonator 3b away from the side wall 12, as shown in FIGS. 14D-14F. Accordingly, the capacitance coupling between the resonator 3a and the resonator 3b is changed, and thus the total coupling between them is tuned. After the coupling tuning is completed, the hole 19 is sealed off by a conductive film or a dielectric film.

In the third embodiment as described above, a plurality of first flexible portion 33 for frequency tuning and a plurality of third flexible portion 35 for coupling tuning are provided, and a plurality of holes 19, 25 are formed in the side walls of the housing 1 and the cover 2 for insertion of a tool, but the holes 19, 25 are sealed off after the frequency tuning or the coupling tuning is completed. Therefore, no signal leakage will occur, and the EMC performance is improved.

While some embodiments of this disclosure are described as above, those skilled in the art can understand that certain features in different embodiments can be combined with each other where appropriate. For example, some of the resonators 3 in the first embodiment or its variant may be provided with one or more of the first flexible portion 33, the second flexible portion 34 and the third flexible portion 35 in the second or third embodiment, and the cover 2, 2′ or the side walls of the housing 1 may be provided with corresponding holes for frequency tuning or coupling tuning.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A filter cover for closing a cavity which is defined by a housing and in which a plurality of resonators is disposed, the filter cover having an inner surface which faces the cavity, wherein the inner surface is provided with at least one flexible flap for frequency tuning or coupling tuning, which extends from and substantially perpendicular to the inner surface.

2. The filter cover according to claim 1, wherein the at least one flexible flap includes a first flexible flap for frequency tuning, which is arranged to substantially overlap a corresponding resonator after the filter cover is joined to the housing.

3. The filter cover according to claim 1, wherein the at least one flexible flap includes a second flexible flap for coupling tuning, which is arranged to be located between two adjacent resonators after the filter cover is joined to the housing.

4. The filter cover according to claim 1, wherein the filter cover is not provided with any hole or slot for tuning.

5. An RF cavity filter, comprising:
a housing defining a cavity;
a plurality of resonators disposed in the cavity-; and
a filter cover according to for closing the cavity, wherein
the filter cover has an inner surface which faces the cavity,
the inner surface is provided with at least one flexible flap for frequency tuning or coupling tuning, which extends from and substantially perpendicular to the inner surface.

6. The RF cavity filter according to claim 5, wherein each of the plurality of resonators extends in a first direction from a first end which is fixed to a bottom wall of the housing to a second end which is directed towards and spaced from the inner surface of the cover.

7. The RF cavity filter according to claim 6, wherein each of the plurality of resonators is made of a sheet metal, and has a body portion extending in a first plane and a folded portion formed at the second end by bending the sheet metal.

8. The RF cavity filter according to claim 7, wherein the folded portion extends substantially in a second plane which is parallel to the inner surface of the cover.

9. The RF cavity filter according to claim 7, wherein the folded portion and the first flexible flap for frequency tuning are arranged at opposite sides of the body portion.

10. The RF cavity filter according to claim 7, wherein the first plane is parallel to a side wall of the housing, and the at least one flexible flap extends in a plane substantially parallel to the first plane and the side wall of the housing.

11. The RF cavity filter according to claim 10, wherein the side wall of the housing is provided with at least one hole at a position corresponding to a free end of the at least one flexible flap.

12. The RF cavity filter according to claim 11, wherein the at least one hole is sealed off after the frequency tuning or the coupling tuning is completed.

13. The RF cavity filter according to claim 5, wherein at least two of the plurality of resonators is made of a single sheet metal.

14. The RF cavity filter according to claim 13, wherein the first ends of the at least two resonators are connected to each other by an integrated coupling line.

15. A resonator for an RF cavity filter, the resonator being made of a sheet metal, extending in a first direction from a first end to a second end, and having a body portion extending in a first plane, wherein the second end is provided with a folded portion which is formed by bending the sheet metal and extends in a second plane substantially perpendicular to the first direction, and an integrated flexible portion which is connected to the folded portion or the body portion and is bendable with respect to the folded portion for frequency tuning or coupling tuning.

16. The resonator according to claim 15, wherein the flexible portion comprises a first flexible portion which extends from a first edge of the folded portion in an opposite direction of the folded portion with respect to the body portion, and an angle between the first flexible portion and the folded portion or the body portion can be changed for frequency tuning.

17. The resonator according to claim 16, wherein the flexible portion comprises a second flexible portion which extends substantially in the second plane from a second edge of the folded portion that is different from the first edge, and an angle between the second flexible portion and the folded portion can be changed for coupling tuning.

18. The resonator according to claim 17, wherein the second flexible portion is substantially in an L shape, comprising a first segment which is connected to the second edge of the folded portion and a second segment which is substantially perpendicular to the first segment.

19. The resonator according to claim 16, wherein the flexible portion comprises a third flexible portion which extends substantially in the first plane from an edge of the body portion, and an angle between the third flexible portion and the body portion can be changed for coupling tuning.

20. The resonator according to claim 19, wherein the third flexible portion is substantially in an L shape, comprising a first segment which is connected to the edge of the body portion and a second segment which is substantially perpendicular to the first segment.

21-30. (canceled)
